(19) United States
(12) Patent Application Publication
(10) Pub. No.: US 2002/0124730 A1
(43) Pub. Date: Sep. 12, 2002

(54) Method and apparatus for separating liquid in a semiconductor cleaning device

(76) Inventor: Richard G. Abraham, Portland, OR (US)

Correspondence Address: SNELL & WILMER L.L.P., One Arizona Center, 400 East Van Buren, Phoenix, AZ, 85004-2202, US

(21) Appl. No.: 09/802,018

(22) Filed: Mar. 8, 2001

(51) Int. Cl. B01D 46/00

(52) U.S. Cl. 95/287; 55/482; 55/485; 55/528

(57) ABSTRACT

A method and apparatus for separating fluid from exhaust air in a semiconductor cleaning device implements a separator box having at least one mesh layer disposed therein to assist in preventing separated fluid from entering exhaust ducting. The mesh layer reduces the amount of splashing and assists in maintaining an even air flow. Additional layers of mesh may be disposed above the first mesh layer to further assist in reducing fluid from entering exhaust ducting.

### BACKGROUND OF THE INVENTION

1. Field of the Invention

The present invention relates to, generally, a method and apparatus for separating liquid from air for use in a semiconductor cleaning device, and more specifically, to a separator for reducing splashing and removing liquid from exhaust air from the cleaning and rinsing of semiconductor wafers prior to exhausting the air from the semiconductor cleaning device.

2. Background

An important step in the semiconductor fabrication process is the cleaning and rinsing of semiconductor wafers. Abrasive slurries, which often include corrosive or hazardous fluidic materials, are used in the cleaning stage of preparing semiconductor wafers. Likewise, corrosive or hazardous fluidic chemicals are used for cleaning wafers before and after cleaning. Due to safety requirements, the fumes from these chemicals are exhausted from the equipment and scrubbed. When the exhaust air is removed from the cleaning chamber, hazardous fluids are often drawn out with the air, as well as being drawn up by the scrub airflow. Ideally, the fluid would fall to a drainage area and would then be removed via a drainage mechanism. However, when the fluids descend, they tend to mix and create a splash when they hit pooled fluid in the drainage area. This poses a problem because the hazardous chemicals tend to splash beyond the protective barriers and enter the exhaust ducting, causing a safety hazard because the hazardous fluids are now being carried into the vent system.

Past attempts to reduce the amount of hazardous fluids introduced into the vent system have been ineffective for a number of reasons. First, these extractors are typically constructed from materials that easily corrode, thereby causing service problems and generating unwanted particles that may enter the vent system. Second, many of these extractors separate liquid from air by forcing the moist air to travel through a winding, treacherous path, thereby requiring the extractor to occupy a large and usually vertically tall area. Finally, due to the extractor's often large and predetermined size, integration and placement within the cleaner may be impossible or very difficult.

Moreover, traditional separator apparatuses are unable to handle the high velocities at which the scrub air is drawn out of the cleaning chamber of the cleaner, and thereby, splashing occurs when the fluidic materials strike a surface. This splashing may enter the exhaust ducting, regardless of whether protective baffles have been incorporated in the design to reduce the amount of fluid that enters the exhaust ducting. The splashed fluid that enters the exhaust ducting further contributes to corroding the ducting, and further, it creates a dangerous environment by exhausting air containing hazardous substances into where humans are likely to be exposed.

Therefore, a need exists for a fluid extraction device that is made of non-corrosive, non-particle generating materials, occupies a relatively compact area, and can assist in preventing fluids from entering the scrub or vent exhaust system.

### SUMMARY OF THE INVENTION

The present invention provides systems and methods that overcome the shortcomings of the prior art. In accordance with one aspect of the present invention, an apparatus for separating liquid in a semiconductor cleaning device separates hazardous fluids from air drawn from the device's cleaning and rinsing chambers through use of at least one mesh layer disposed within a separator box. The mesh layer reduces the amount of splashing caused when hazardous fluid is drawn out with the exhaust air and may assist in creating a more even airflow.

In accordance with another aspect of the present invention, a method of extracting fluid comprises providing a separator box having a top, bottom, and sides, wherein air containing hazardous fluids enters the separator box via an inlet duct, has the splashing of the fluids reduced by the implementation of at least one mesh layer, and exits the separator box through an exhaust duct.

In accordance with another aspect of the present invention, a method of manufacturing a separator box includes coupling a top, bottom, and three sides to one another, inserting mesh layers into recesses within the separator box, introducing inlet ducting through the inlet aperture disposed within the top, adjusting the mesh layers to correspond with recesses in the inlet ducting, and adding a fourth side to complete the separator box.

### BRIEF DESCRIPTION OF THE DRAWING FIGURES

The subject invention will hereinafter be described in conjunction with the appended drawing figures, wherein like numerals denote like elements, and:

FIG. 1 is a side cross-section view of a separator box;

FIG. 2 is a top view of the separator box of FIG. 1;

FIG. 3 is a rear of the separator box of FIG. 1;

FIG. 4 is a front cross-section view of the separator box of FIG. 1;

FIG. 5 is a side cross-section view of a separator box having inlet ducting entering the separator box from the side;

FIG. 6 is a front view of the separator box of FIG. 5;

FIG. 7 is a side cross-section view of a separator box having two inlet ducts;

FIG. 8 is a top view of the separator box of FIG. 7;

FIG. 9 is a rear of the separator box of FIG. 7; and

FIG. 10 is a front cross-section view of the separator box of FIG. 7.

### DETAILED DESCRIPTION OF EXEMPLARY EMBODIMENTS

The subject invention relates to the separation of hazardous fluid from air drawn from cleaning and rinsing chambers of a semiconductor cleaning apparatus by implementing mesh layers that assist in controlling air flow and splashing in a separator box. The aspects of the invention set forth herein do not limit the scope of the invention and are presented to enable a person skilled in the art to more readily appreciate the invention.

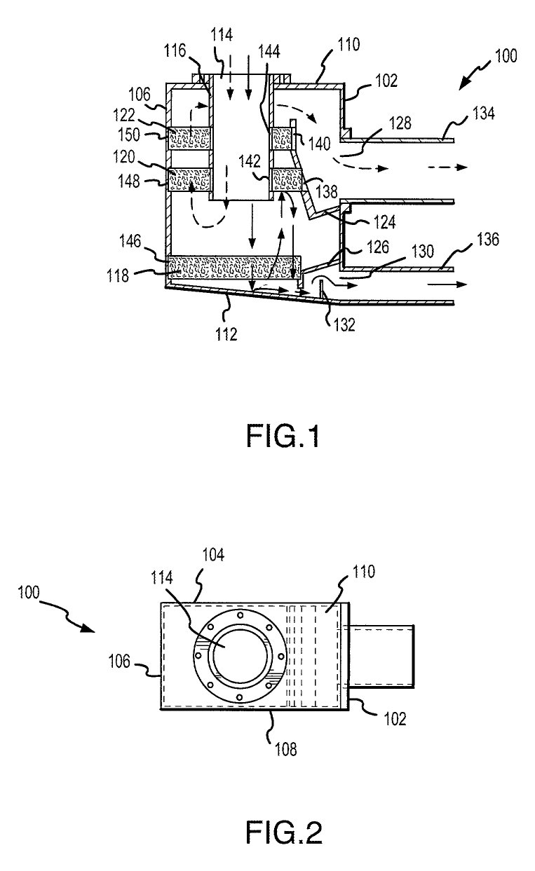

In accordance with one aspect of the present invention, FIG. 1 illustrates separator box 100 having sides 102, 104, 106, and 108 (as seen in FIG. 2), top 110, and bottom 112. It should be appreciated that separator box 100 is not limited to a rectangular shape, and that the illustration of a rectangular separator box 100 is merely one example of the numerous shapes in which separator box 100 may be constructed; in fact, the perimeter of separator box 100 may be of any shape that may be incorporated into a semiconductor cleaning device. Separator box 100 may be constructed of any material known in the art, for example a non-corrosive material such as clear polyvinyl chloride, polypropylene, and the like.

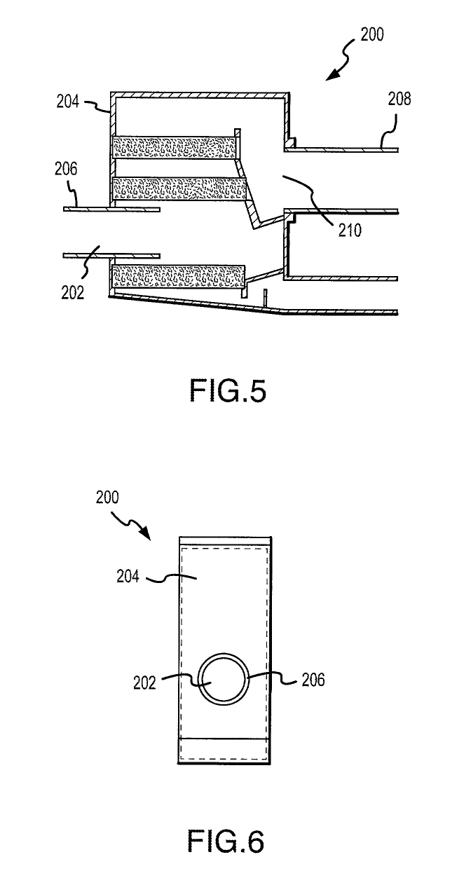

Inlet aperture 114 may be suitably disposed in top 110 to permit the insertion of inlet duct 116 into separator box 100. Inlet aperture 114 may also be suitably disposed along any of the sides (regardless of perimeter shape of separator box 100), so long as fluid entering separator box 100 through inlet aperture 114 is unlikely to directly exit through exhaust aperture 128. For example, FIGS. 5 and 6 illustrate a separator box 200 wherein inlet aperture 202 is suitably disposed in side 204 and provides for the insertion of inlet duct 206 through side 204. As shown in FIG. 5, inlet duct 202 is suitably offset from exhaust duct 208 such that fluid is unlikely to directly exit through exhaust aperture 210.

Referring back to FIG. 1, inlet duct 116 may be coupled to separator box 100 in any way known in the art, for example with a mating flange and O-ring seal, PVC glue, NPT threads, or any other mechanical-type seal.

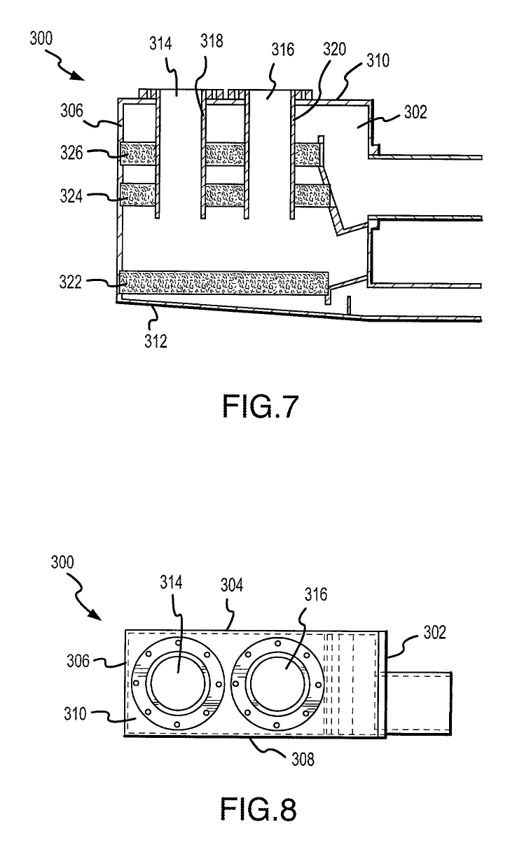

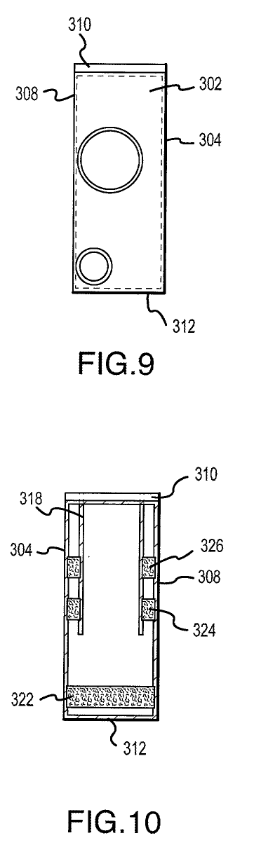

It should also be appreciated that separator box 100 may have more than one inlet aperture and may have more than one inlet duct as required by the particular design. Referring to FIGS. 7-10, separator box 300 has sides 302, 304, 306, and 308 (as seen in FIG. 8), top 310, and bottom 312. Top 310 has inlet apertures 314 and 316 to accommodate inlet ducts 318 and 320. Mesh layers 324 and 326 each provide apertures to permit the insertion of inlet ducts 318 and 320 therethrough.

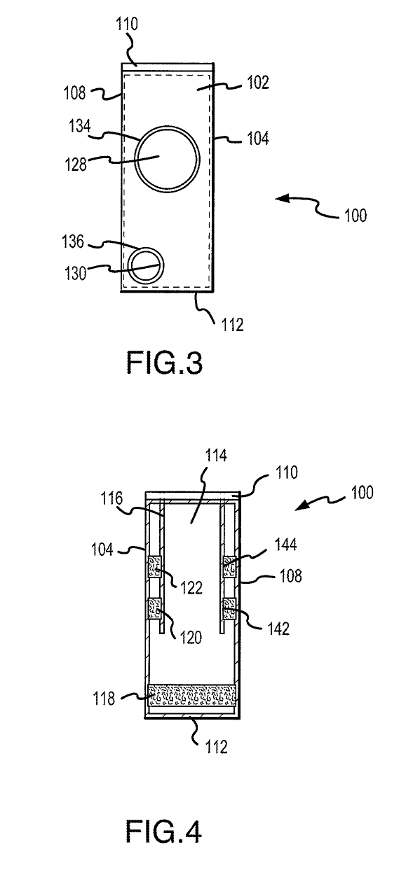

Referring back to FIGS. 1-4, hazardous fluids exit the CMP's cleaning and rinsing chambers and enter separator box 100 through inlet duct 116. The fluids gain speed due to gravity and due to the velocity of the scrub air. The descending fluid would typically strike other fluid that is waiting to be drained out through drain duct 136. The result would likely be a splash of fluid that may circumvent baffle 124 in the absence of a material that reduces the fluid splashing and does not impede the exhaust air flow, as discussed further below.

Referring to FIG. 1, baffle 124 may be constructed of any material known in the art, for example, the materials selected for the sides of the separator box 100, and is preferably constructed of the same material as the separator box 100 side to which it is affixed; further, baffle 124 may be affixed to the interior portion of side 102 through any known techniques known in the art, including traditional welding, cold welding, adhesives and the like. Baffle 124 may be of any shape that acts to prevent fluid from entering exhaust duct 134, yet, preferably, does not significantly impede air flow out of separator box 100, and is suitably configured within separator box 100 to assist in preventing splashing liquid from entering exhaust duct 134. Additionally, baffle 124 may optionally have recesses 138 and 140 suitably disposed therein to allow for the insertion of mesh layers 120 and 122.

Scrub air (represented in FIG. 1 by broken arrows), containing fluids used in the cleaning and rinsing of semiconductor wafers during the CMP process (represented in FIG. 1 by solid arrows and is usually corrosive materials like hydrofluoric acid and other hazardous materials, as well as pieces of debris from broken semiconductor wafers), is drawn into separator box 100 through inlet ducting 116. Due to the high velocity that hazardous liquid enters separator box 100, splashing may occur when the liquid strikes bottom 112 or strikes any fluid that may have accumulated in bottom 112. To assist in reducing splashing upon entering separator box 100, a first mesh layer 118 is suitably disposed toward the bottom of separator box 100 such that splashing from the fluids (drawn into separator box 100 through exhaust ducting 116) is reduced.

Mesh layer 118 assists in reducing splashing by dampening the impact of the descending fluid on the fluid waiting to be drained out through drain duct 136. Mesh layer 118 may be coupled with baffle 126 by any method known in the art, such as through traditional or cold welding, adhesion, or by insertion into recesses on baffle 126, or mesh layer 118 may be coupled to directly to the inside of wall 102 as described above. Mesh layers 118, 120, and 122 may be any known material in the art, such as a non-corrosive material such as polyvinyl chloride, for example, P/N 5525 from Musashino Giken Co. Ltd. of Japan, and may be of any thickness that acts to reduce the amount of liquid that enters exhaust duct 134, preferably 10 mm. to 50 mm.

Mesh layer 120 further assists in preventing splashing from circumventing baffle 124 and reaching exhaust duct 134 by providing a screen that reduces or prevents liquid splashes from proceeding around and over the top of baffle 124 into exhaust duct 134. Further, the addition of mesh layer 120 does not significantly increase the velocity of exhausting scrub air because the spacing throughout mesh layer 120 allows the even passage of air. Mesh layer 122 may function in a similar fashion as mesh layer 120 in that air flow is not significantly impeded, and may also assist in the situations where the level of fluid in separator box 100 is high due to large amounts of fluid that may enter separator box 100 during high fluid volume phases of the cleaning process.

When fluid drains out of the cleaning and rinsing chambers of a semiconductor cleaning device, descending fluid typically strikes mesh layer 118 and then diffuses through mesh layer 118 to the bottom 112 of separator box 100. Bottom 112 may optionally be angled to assist in directing fluid toward drain duct 136. Protrusion 132 may optionally be included to create a “P” trap type of drain path which prevents scrub air from being pulled through the drain duct 136 through drain aperture 130. This assists in increasing overall separator box 100 efficiency.

In accordance with one method of constructing separator box 100, sides 102, 104, and 108 are coupled to bottom 112 and top 110 through any method known in the art, such as traditional welding, cold welding, adhesives, and the like. Baffles 124 and 126 may be affixed to the interior portion of side 102 either prior to or after side 102 is affixed to sides 104 and 108, bottom 112, and top 110. Mesh layers 118, 120, and 122 may then be placed at their respective positions and may be affixed by the techniques described above, as well as utilizing corresponding recesses 140 and 142 along inlet duct 116. When inlet ducting 116 is inserted through aperture 114 in top 110, inlet duct 116 passes through a corresponding aperture disposed in mesh layers 120 and 122. After inlet duct 116 is inserted to its desired location, mesh layers 120 and 122 may be guided to properly rest in recesses 142 and 144 in inlet duct 116 (as shown in FIGS. 1 and 4). Side 106 is then affixed to separator box 100 as described above, wherein mesh layers 118, 120, and 122 are, respectively, inserted into recesses 146, 148, and 150 which are disposed within the interior of side 106.

Although the subject invention is described herein in conjunction with the appended illustrative, not-to-scale drawings, it will be appreciated that the invention is not limited to the specific form shown. Various modifications in the selection and arrangement of parts, components, and processing steps may be made in the implementation of the invention. For example, virtually any type non-corrosive material may be used in constructing the body and mesh layers. Further, adjustments to the system, such as changing the position of the inlet duct and exhaust duct and changing the manner of coupling components together, is within the scope of this disclosure. These and other modifications may be made in the design and arrangement of the various components that implement the invention without departing from the spirit and scope of the invention as set forth in the appended claims.

What is claimed is:

1. An apparatus for separating fluid in a semiconductor cleaning device comprising:
a separator box having a top, bottom, and sides;
an inlet aperture disposed in said separator box to permit air containing fluid to enter said separator box;
an exhaust aperture disposed in said separator box to permit air to exit said separator box; and
at least one layer of mesh disposed within said separator box.

2. An apparatus for separating fluid in a semiconductor cleaning device according to claim 1 wherein said mesh is comprised of at least one of a polyvinyl chloride and polypropylene.

3. An apparatus for separating fluid in a semiconductor cleaning device according to claim 1 further comprising a second layer of mesh.

4. An apparatus for separating fluid in a semiconductor cleaning device according to claim 3 further comprising a third layer of mesh.

5. An apparatus for separating fluid in a semiconductor cleaning device according to claim 4 wherein said mesh is polyvinyl chloride.

6. An apparatus for separating fluid in a semiconductor cleaning device according to claim 1 wherein said inlet aperture is configured in said top of said separator box.

7. An apparatus for separating fluid in a semiconductor cleaning device according to claim 1 wherein said inlet aperture is configured in at least one of said sides of said separator box.

8. An apparatus for separating fluid in a semiconductor cleaning device according to claim 1 further comprising at least one additional inlet aperture.

9. An apparatus for separating fluid in a semiconductor cleaning device according to claim 5 wherein said separator box is comprised of at least one of a polyvinyl chloride and polypropylene.

10. An apparatus for separating fluid in a semiconductor cleaning device according to claim 1 wherein there are at least two layers of mesh and at least one layer of said at least two layers of mesh has an aperture.

11. A method for separating fluid from air in a semiconductor cleaning device comprising the steps of:
providing a separator box having a top, bottom, and sides, an inlet aperture disposed in said separator box to permit air containing fluid to enter said separator box, an exhaust aperture disposed in said separator box to permit air to exit said separator box; and at least one layer of mesh disposed within said separator box;
drawing air containing fluid from another chamber of said semiconductor cleaning device;
allowing said fluid to enter said separator box such that said mesh layers reduce the amount of said fluid that exits through said exhaust aperture.

12. A method for separating fluid from air in a semiconductor cleaning device according to claim 11 wherein said at least one layer of mesh is selected from the group consisting of polyvinyl chloride and polypropylene.

13. A method for separating fluid from air in a semiconductor cleaning device according to claim 11 further comprising the step of providing a second layer of mesh.

14. A method for separating fluid from air in a semiconductor cleaning device according to claim 13 further comprising the step of providing a third layer of mesh.

15. A method for separating fluid from air in a semiconductor cleaning device according to claim 14 wherein said mesh is polyvinyl chloride.

16. A method for separating fluid from air in a semiconductor cleaning device according to claim 11 further comprising the step of providing at least two layers of mesh wherein at least one layer of said at least two layers of mesh has an aperture for the passing of an inlet duct.

17. A method for separating fluid from air in a semiconductor cleaning device according to 11 wherein said inlet aperture is configured in said top of said separator box.

18. A method of manufacturing an apparatus for separating fluid from air in a semiconductor cleaning device comprising the steps of:
providing a top, bottom, and three sides, said top having at least one inlet aperture and at least one of said three sides having an exhaust aperture and a drain aperture;
coupling said top, said bottom, and said three sides to one another;
inserting a first layer of mesh such that said first layer of mesh rests in recesses disposed in said sides; and
coupling a fourth side to said top, said bottom, and said three sides

19. A method of manufacturing an apparatus for separating fluid from air in a semiconductor cleaning device according to claim 18 further comprising the following steps:
providing a second layer of mesh above said first layer of mesh, said second layer of mesh having an aperture disposed therein;
inserting an inlet duct through said inlet aperture in said top and through said aperture in said second layer of mesh; and
adjusting said second layer of mesh such that it rests in recesses disposed in said at least one inlet duct.

20. A method of manufacturing an apparatus for separating fluid from air in a semiconductor cleaning device according to claim 18 further comprising the step of providing a third layer of mesh above said first layer of mesh and said second layer of mesh, said third layer of mesh having an aperture disposed therein.
